(19) United States
(12) Patent Application Publication
(10) Pub. No.: US 2019/0066533 A1
(43) Pub. Date: Feb. 28, 2019

(54) METHODS FOR FACILITATING SHORTCUT AND HOT KEY LEARNING VIA COMPUTER APPLICATION GAMIFICATION AND DEVICES THEREOF

(71) Applicants: Tatiana Ufimtceva, Water Mill, NY (US); Aleksandr Ufimtcev, Vologda (RU)

(72) Inventors: Tatiana Ufimtceva, Water Mill, NY (US); Aleksandr Ufimtcev, Vologda (RU)

(21) Appl. No.: 16/119,200

(22) Filed: Aug. 31, 2018

Related U.S. Application Data
(60) Provisional application No. 62/605,897, filed on Aug. 31, 2017.
(60) Provisional application No. 62/641,566, filed on Mar. 12, 2018.

(51) Int. Cl. G09B 19/00; G06F 3/0489

(52) U.S. Cl. CPC G09B 19/0053; G06F 3/0236; G06F 3/04895

(57) ABSTRACT

Methods, non-transitory computer readable media, and application gamification computing devices that more effectively and efficiently facilitate learning of computer application shortcuts and hot keys are disclosed. With this technology, a display screen comprising a simulation of a computer application and an indication of an interaction with the computer application that can be initiated via a shortcut or hot key is output. Key presses corresponding to the shortcut or hot key are received. The simulation is updated to reflect performance of the interaction within the computer application in response to the key presses. A stored performance is updated to reflect completion of a portion of one of a plurality of subtopics. Each of the subtopics corresponds to a category of shortcut or hot key utilization. An indication of the performance is output in response to a received request. The indication of the performance comprises a completion status for the subtopics.

This application claims the benefit of U.S. Provisional Patent Application Ser. No. 62/605,897, filed Aug. 31, 2017, and U.S. Provisional Patent Application Ser. No. 62/641,566, filed Mar. 15, 2018, each of which is hereby incorporated by reference in its entirety.

### FIELD

This technology relates generally to improved computer application training and, more particularly, to methods and devices for facilitating shortcut and hot key learning via computer application gamification.

### BACKGROUND

Training for computer applications is currently ineffective, resulting in inefficient utilization of applications by employees and other users. In particular, automated application training utilities do not effectively teach shortcuts and hot keys. Accordingly, shortcuts and hot keys are generally not utilized to their full potential by employees and tasks take longer than necessary to complete. For relatively large organizations in which a relatively large number of employees are utilizing the same application(s) (e.g., a spreadsheet application), the inefficiency is compounded and can have a significant and negative impact on productivity and the organization's available resources.

### BRIEF DESCRIPTION OF THE DRAWINGS

FIG. 1 is a block diagram of a network environment with an exemplary application gamification computing device;

FIG. 2 is a flowchart of an exemplary method for facilitating shortcut and hot key learning via computer application gamification;

FIG. 3 is a screenshot of an exemplary topic selection display screen;

FIG. 4 is a screenshot of an exemplary subtopic selection display screen;

FIG. 5 is a screenshot of an exemplary interaction mode selection display screen;

FIG. 6 is a screenshot of an exemplary learning mode display screen;

FIG. 7 is a screenshot of an exemplary testing mode display screen;

FIG. 8 is a screenshot of an exemplary performance display screen;

FIG. 9 is a screenshot of another exemplary testing mode display screen;

FIG. 10 is a screenshot of an exemplary performance display screen;

FIG. 11 is a screenshot of a main administrator performance display screen; and

FIG. 12 is a screenshot of a module detail administrator performance display screen.

### DETAILED DESCRIPTION

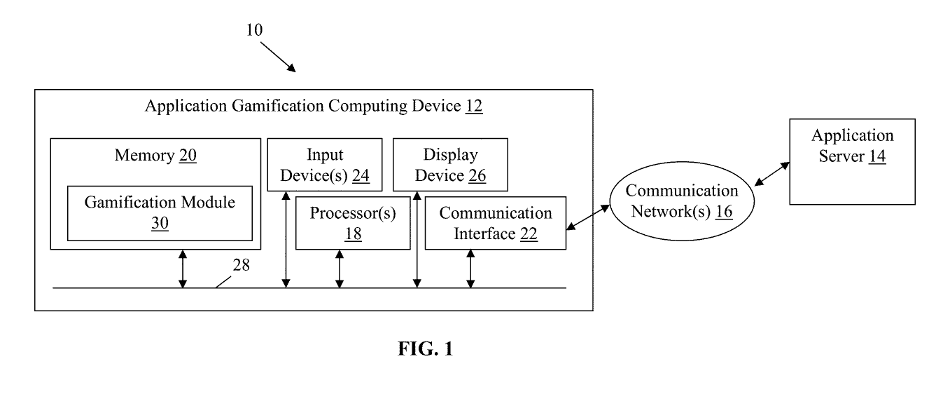

Referring to FIG. 1, a network environment 10 includes an exemplary application gamification computing device 12 optionally coupled to an application server 14 via communication network(s) 16 is illustrated. The application gamification computing device 12 in this example includes processor(s) 18, memory 20, a communication interface 22, an input device 24, and a display device 26, which are coupled together by a bus 28 or other communication link, although the application gamification computing device 12 can include other types and/or numbers of elements in other configurations. This technology advantageously facilitates more effective shortcut and hot key learning via computer application gamification to improve the efficiency of users interacting with computer applications.

The processor(s) 18 of the application gamification computing device 12 may execute programmed instructions stored in the memory 20 for the any number of the functions described and illustrated herein. The processor(s) 18 of the application gamification computing device 12 may include one or more CPUs or general purpose processors with one or more processing cores, for example, although other types of processor(s) can also be used.

The memory 20 of the application gamification computing device 12 stores these programmed instructions for one or more aspects of the present technology as described and illustrated herein, although some or all of the programmed instructions could be stored elsewhere. A variety of different types of storage devices, such as random access memory (RAM), read only memory (ROM), hard disk, solid state drives, flash memory, or other computer readable medium which is read from and written to by a magnetic, optical, or other reading and writing system that is coupled to the processor(s) 18, can be used for the memory 20.

Accordingly, the memory 20 of the application gamification computing device 12 can store one or more applications that can include executable instructions that, when executed by the application gamification computing device 12, cause the application gamification computing device 12 to perform actions, such as to transmit, receive, or otherwise process network messages, receive and process inputs from the input device(s) 24, and/or output display screens to the display device 26, for example, and to perform other actions described and illustrated below. The application(s) can be implemented as modules or components of other applications.

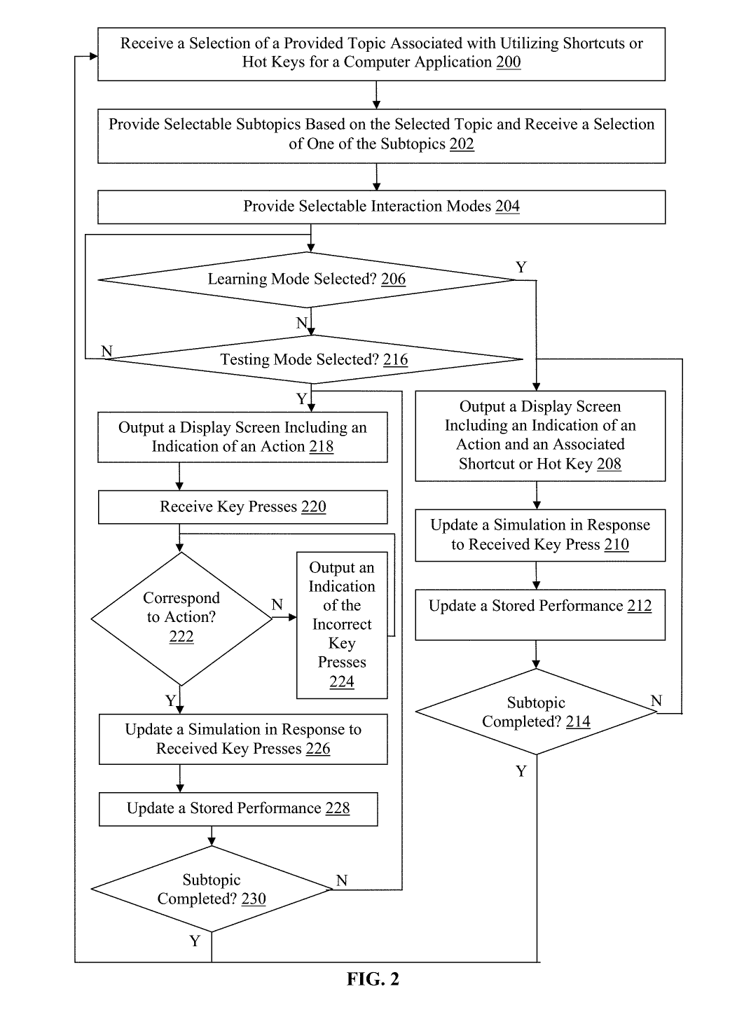

In this particular example, the memory 20 of the application gamification computing device 12 includes a gamification module 30, although the memory can include other modules, data structures, or applications, for example. The gamification module 30 in this example is configured to provide display screens that are navigable using key presses received from the input device 24 in order to simulate interactions with computer application(s) and train users, as described and illustrated in more detail with reference to FIGS. 2-12. The memory 20 of the application gamification computing device 12 can also include an operating system in some examples, which can be MacOS™, iOS™, Windows™, Android™, or any other type of operating system that provides resources of the application gamification computing device 12 to the gamification module 30.

The communication interface 22 of the application gamification computing device 12 operatively couples and communicates between the application gamification computing device 12 and the application server 14. By way of example only, the communication network(s) 16 can include local area network(s) (LAN(s)) or wide area network(s) (WAN(s)), and can use TCP/IP over Ethernet and industry-standard protocols, although other types and/or numbers of protocols and/or communication networks can be used. The communication network(s) 16 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The input device(s) 24 of the application gamification computing device 12 in this example include at least a keyboard, but can optionally also include a mouse, trackball, or other type of input device. The display device 26 of the application gamification computing device 12 can include a monitor, touch screen, or any other type of device capable of displaying content generated by the gamification module 30. Accordingly, the application gamification computing device 12 in this example can be based on a personal computer (PC), smartphone, tablet, laptop, or any other type of computing device platform.

The optional application server 14 in this example includes processor(s), memory, and a communication interface, which are all coupled together by a bus or other communication link. In examples in which the application server 14 is utilized, access by client devices (not shown) to the gamification module 30 can be in a distributed fashion via the communication network(s) 16. Accordingly, the gamification module 30 can be locally installed and/or executable, or remotely accessible as a downloaded application or web application hosted by the application server 14, and other types of implementations are also possible.

Additionally, other types and/or numbers of systems, devices, components, and/or elements in other configurations can also be used in other examples. It is to be understood that the systems of the examples described herein are for exemplary purposes, as many variations of the specific hardware and software used to implement the examples are possible, as will be appreciated by those skilled in the relevant art(s).

The examples may also be embodied as one or more non-transitory computer readable media having instructions stored thereon for one or more aspects of the present technology as described and illustrated by way of the examples herein. The instructions in some examples include executable code that, when executed by one or more processors, such as processor(s) 18, cause the processor(s) to carry out steps necessary to implement the methods of the examples of this technology that are described and illustrated herein.

An exemplary method of facilitating shortcut and hot key learning via computer application gamification will now be described with reference to FIGS. 2-12. Referring more specifically to FIG. 2, a flowchart of an exemplary method of facilitating shortcut and hot key learning via computer application gamification is illustrated. In step 200 in this example, the application gamification computing device 12 receives a selection of a topic associated with utilizing shortcuts or hot keys for a computer application.

The topics can be provided on a display screen by the gamification module 30, for example. Additionally, the selections with this technology can be made by a user of the application gamification computing device 30 using a keyboard one of the input device(s) 24. Accordingly, this technology advantageously facilitates navigation between display screens, and interaction with the display screens, using only received inputs from a keyboard (i.e. without requiring a mouse or other input device).

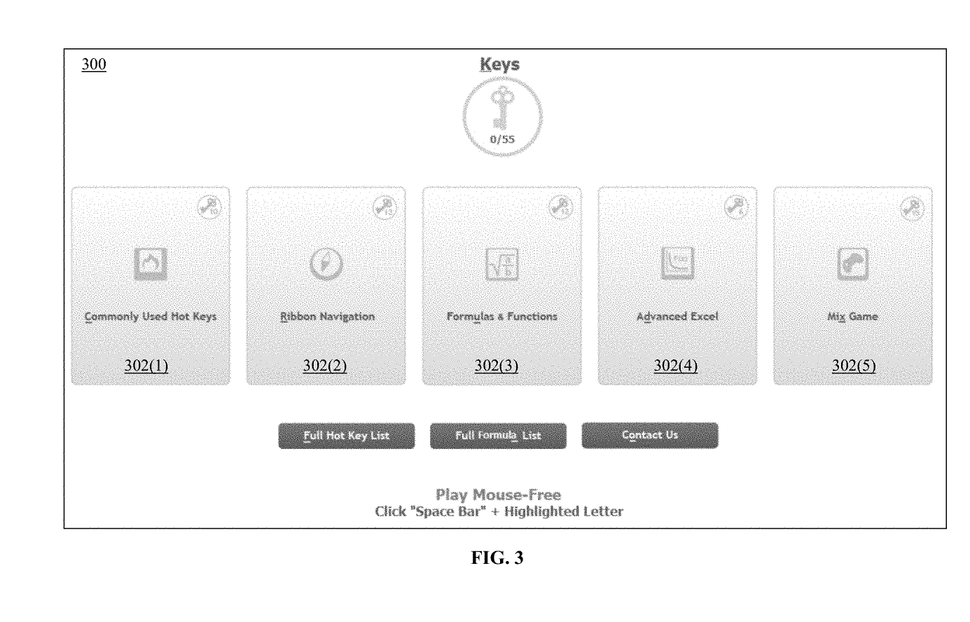

Referring to FIG. 3, a screenshot of an exemplary topic selection display screen 300 is illustrated. In this example, the selectable topics 302(1)-302(5) included on the topic selection display screen 300 include “commonly used hot keys,” “ribbon navigation,” and “formulas and functions,” among others, relating to the Microsoft Excel™ computer application, although other types or number of topics could be used in other examples. While the examples described and illustrated herein related to Microsoft Excel™, this technology can be utilized to facilitate shortcut and hot key learning for any type of computer application including Microsoft PowerPoint™, Word™, or Outlook™, or Adobe Photoshop™, for example.

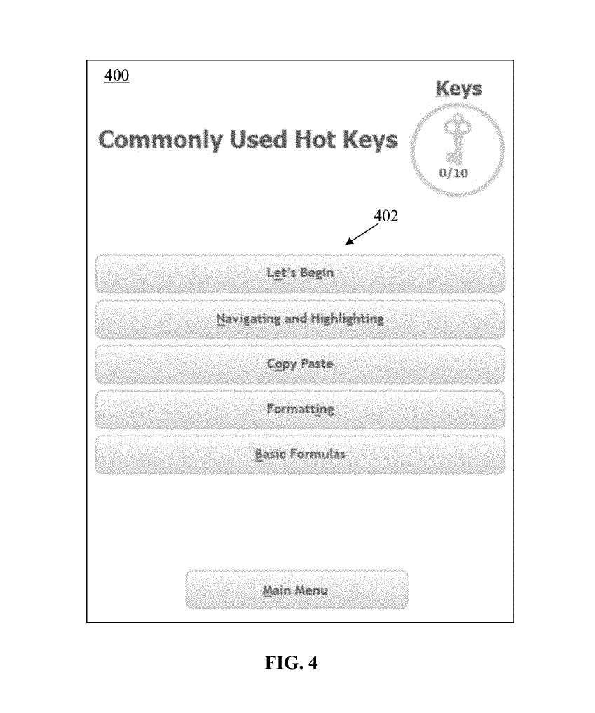

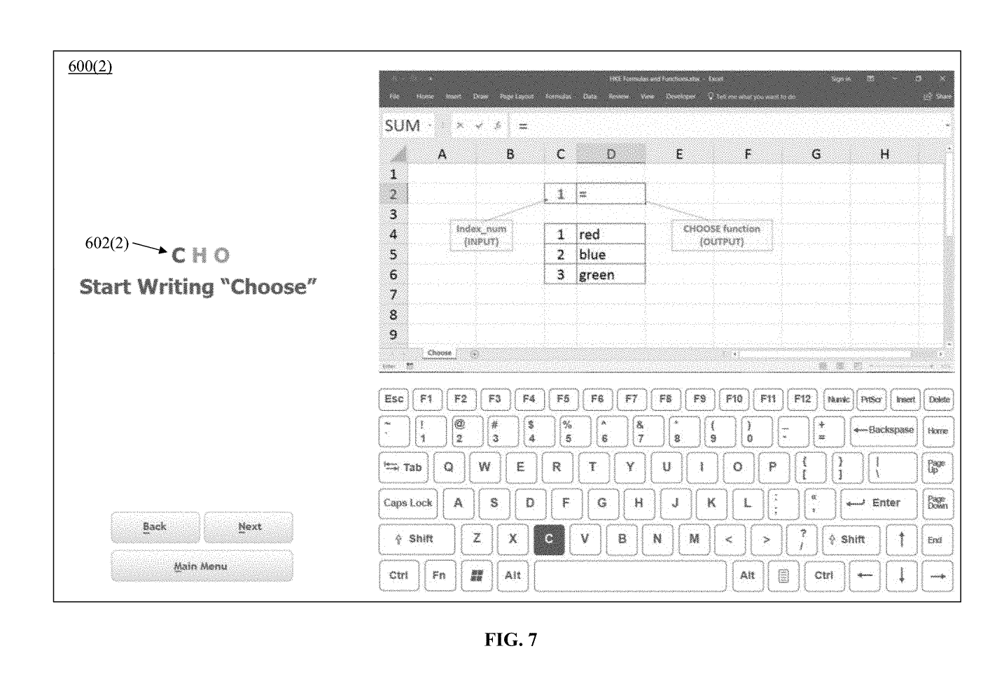

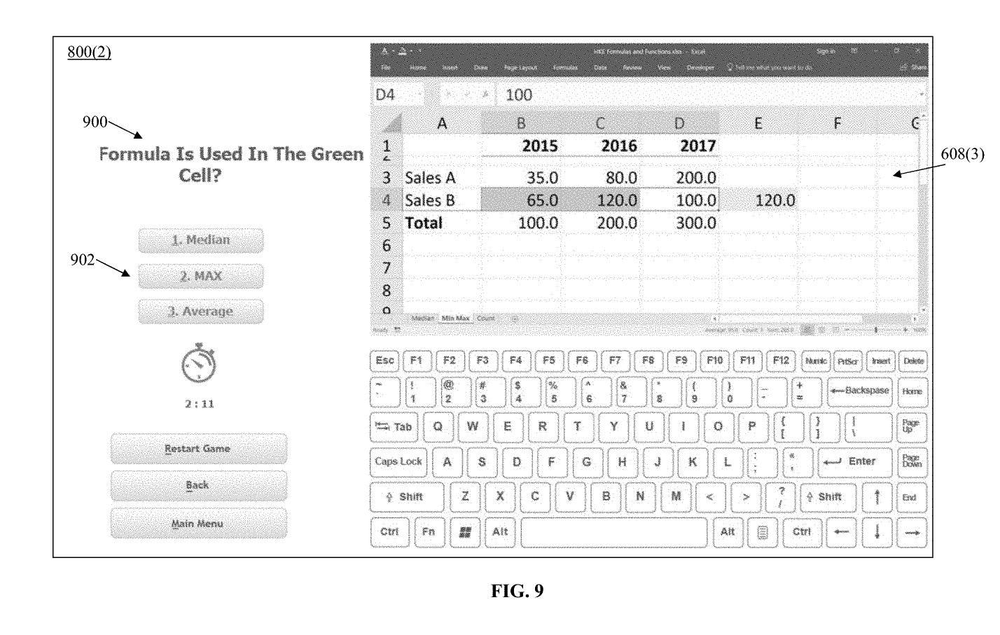

Referring back to FIG. 2, in step 202, the application gamification computing device 12 provides selectable subtopics based on the selected topic, and receives a selection of one of the subtopics. Referring to FIG. 4, a screenshot of an exemplary subtopic selection display screen 400 is illustrated. In this example, the subtopics 402 relating to the “commonly used hot keys” topic 302(1), selected from the topic selection display screen 300 illustrated in FIG. 3, includes “let's begin,” navigating and highlighting,” and “copy paste,” among others. While some of the examples described and illustrated herein relate to commonly used hot keys for Microsoft Excel™, this technology can also facilitate hot key learning for other aspects of Microsoft Excel™ including formulas and analysis, such as building financial models, discounted free cash flow analysis, and/or leveraged buyout analysis, for example, as described and illustrated in more detail later with reference to FIGS. 7 and 9.

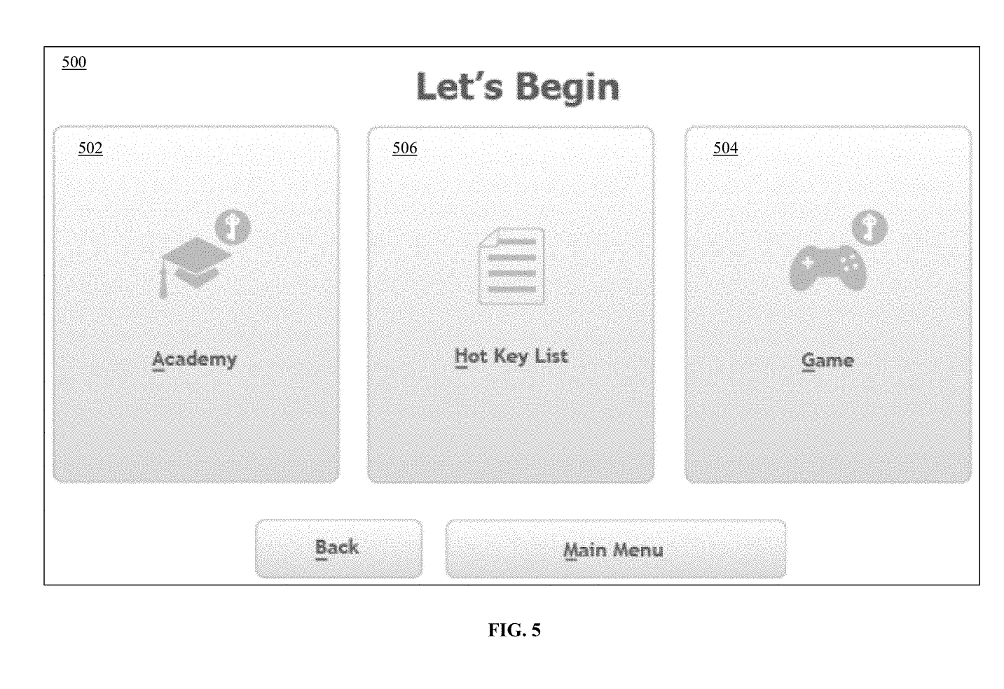

Referring back to FIG. 2, in step 204, the application gamification computing device 12 provides selectable interaction modes, such as learning and testing modes, which are also referred to herein as “academy” and “game” modes. Referring to FIG. 5, a screenshot of an exemplary interaction mode selection display screen 500 is illustrated. In this example, the academy or learning mode 502 facilitates learning by a user of shortcuts and hot keys through presentation of the key presses that correspond to actions within a computer application.

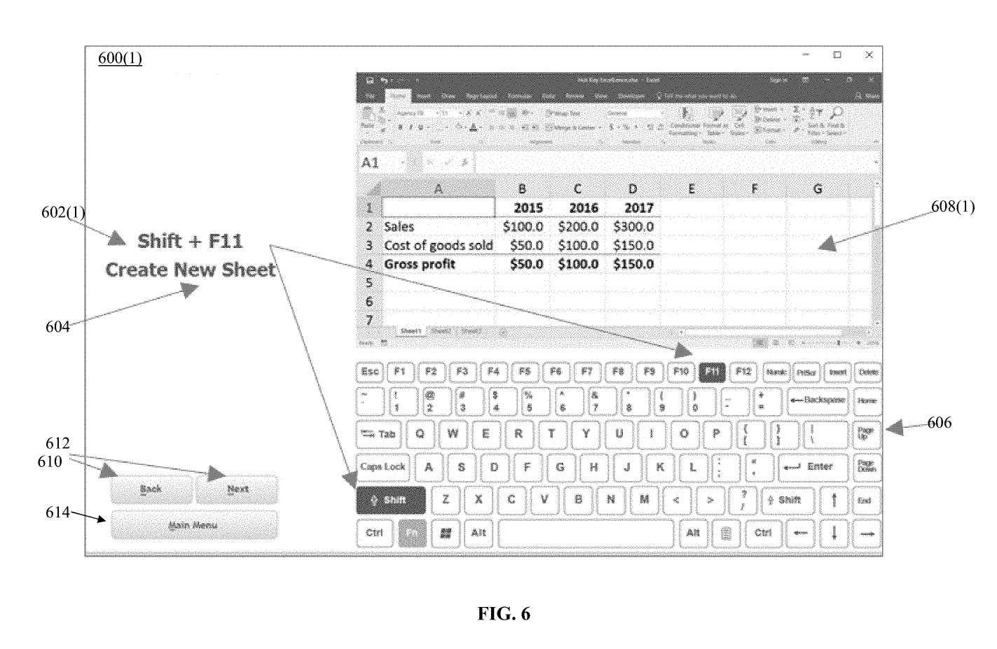

In the game or testing mode 504, the gamification module tests user knowledge of shortcuts and hot keys associated with a computer application. The operation of the academy and game modes in this example will be described and illustrated in more detail later with reference to FIGS. 6 and 7, respectively. In this example, the interaction mode selection display screen 500 also includes a hot key list selection 506, which can present on the display device 26 another display screen with all of the hot keys associated with the particular selected one of the subtopics 402. Other types or number of modes or selections can also be utilized in other examples.

Referring back to FIG. 2, in step 206, the application gamification computing device 12 determines whether a learning mode was selected from the interaction mode selection display screen, for example. If the application gamification computing device 12 determines that the learning mode was selected, then the Yes branch is taken to step 208.

In step 208, the application gamification computing device 12 outputs a display screen including an indication of an action and an associated shortcut or hot key. The display screen in this example further includes a simulation of a computer application and a simulated keyboard. The simulation of the computer application is engaged to reflect the indicated action associated with the shortcut or hot key upon receiving the key presses corresponding to the action. Additionally, the simulated keyboard optionally identifies (e.g., by color or other highlight) the key presses of the shortcut or hot key that is associated with the indicated action.

Referring to FIG. 6, a screenshot of an exemplary learning mode display screen 600(1) is illustrated. In this example, the learning mode display screen 600(1) includes a hot key indication 602 of “shift+F11,” which is associated with a “create new sheet” action 604. Inclusion of the “+” in this example indicates that the keys are to be pressed concurrently to initiate the action 604. In other examples, exclusion of the “+” indicates that the keys are to be pressed sequentially to initiate the action 604. The learning mode display screen 600(1) further provides a color for the “shift” and F11″ keys in the simulated keyboard 606 to indicate to a user the location of the keys required to be pressed in order to initiate the associated hot key 602 and generate the “create new sheet” action 604.

Upon receiving key presses corresponding to the “shift+F11” hot key 602, the simulation of Microsoft Excel™ in a simulation portion 608(1) of the learning mode display screen 600(1) is updated to reflect a result of the “create new sheet” action 604. In this example, a user can also initiate a back button 610, a next button 612, or a main menu button 614 using a keyboard one of the input device(s) 24 in order to navigate between display screens, and other types of selectable buttons and other features can also be provided on the learning mode display screen 600(1) in other examples. With this technology, any action can advantageously be initiated using only received inputs from the keyboard one of the input device(s) 24.

Referring to FIG. 7, a screenshot of another exemplary learning mode display screen 600(2) is illustrated. In this example, the learning mode display screen 600(2) can be output following selection of a different one of the subtopics 602 to that used to obtain the learning mode display screen 600(1) of FIG. 6. The exemplary learning mode display screen 600(2) in this example includes a “C H O” hot key 602(2) which is associated with a choose function that can be entered as part of a formula in a cell of a spreadsheet or worksheet, for example. Other types of functions and formulas can be used in learning mode display screens in other examples.

Referring back to FIG. 2, in step 210, the application gamification computing device 12 updates a simulation in response to received key presses. The received key presses correspond to the shortcut or hot key associated with the action, as output to a display screen in step 208, and described and illustrated in more detail earlier with reference to FIGS. 6-7. Accordingly, a user of the application gamification computing device 12 can effectively initiate the shortcut or hot key and perform the action on the computer application, thereby gaining muscle memory of the shortcut or hot key and facilitating improved learning of efficient interactions with the computer application.

In step 212, the application gamification computing device 12 optionally updates stored performance data for a user to indicate that a particular shortcut or hot key, which is a portion of the shortcuts or hot keys associated with the subtopic selected in step 202, has been completed. The maintenance and utilization of the stored performance data is described and illustrated in more detail later with reference to step 226 of FIG. 2 and FIGS. 10-12.

In step 214, the application gamification computing device 12 determines whether the subtopic selected in step 202 has been completed with respect to all of the associated shortcuts or hot keys. If the application gamification computing device 12 determines that the subtopic has not been completed, then the No branch is taken and the application gamification computing device 12 proceeds back to step 208 and outputs another display screen that includes an indication of another action and associated shortcut or hot key corresponding to the subtopic selected in step 202.

However, if the application gamification computing device 12 determines in step 214 that the subtopic has been completed, then the Yes branch is taken back to step 200 in this example and the main menu is provided (e.g., topic selection display screen 300 is output), as described and illustrated in more detail earlier. In other examples, the application gamification computing device 12 can take other actions in response to determining whether the subtopic has been completed.

Referring back to step 206, if the application gamification computing device 12 determines that the learning mode has not been selected from the interaction modes display screen output in step 204, then the No branch is taken to step 216. In step 216, the application gamification computing device 12 determines whether the testing mode has been selected from the interaction modes display screen output in step 204. If the application gamification computing device determines 12 that the testing mode has not been selected, then the No branch is taken back to step 206, and the application gamification computing device 12 effectively waits for an interaction mode to be received in this example.

However, if the application gamification computing device 12 determines that the testing mode has been selected, then the Yes branch is taken to step 218. In step 218, the application gamification computing device 12 outputs a display screen including an indication of an action. The display screen in this example further includes a simulation of a computer application and a simulated keyboard. The simulation of the computer application is engaged to reflect the indicated action associated with the shortcut or hot key upon receiving the key presses corresponding to the action.

The display screen output by the application gamification computing device 12 in step 218 does not include the indication of a shortcut or hot key associated with the action. The display screen also does not identify on the simulated keyboard the key presses required to initiate the action. Accordingly, the user is required to initiate the shortcut or hot key corresponding to the indicated action without clues that identify the required key presses, in contrast to the display screen output in step 208.

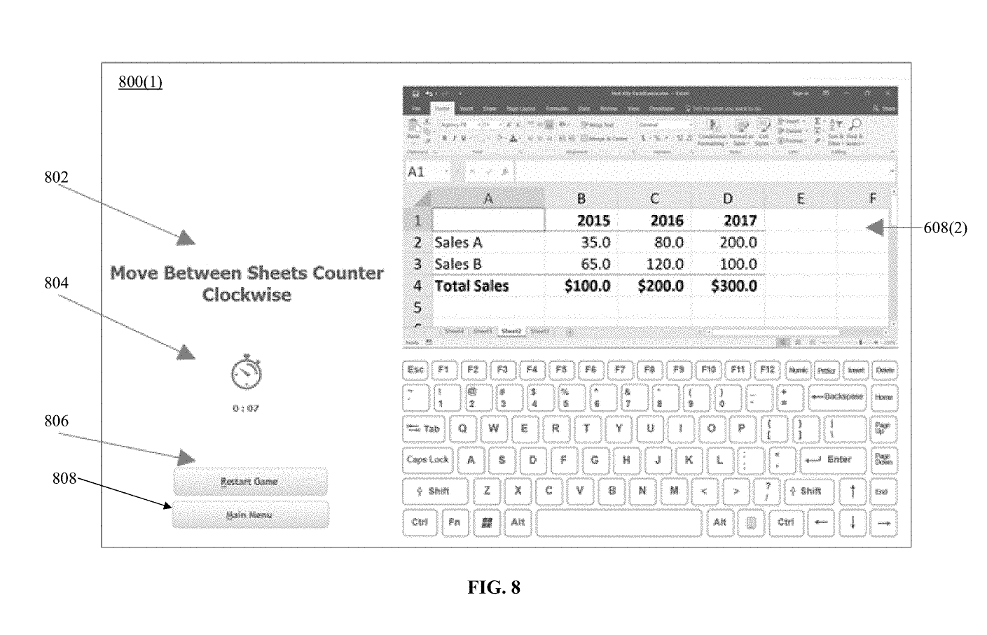

Referring to FIG. 8, a screenshot of an exemplary testing mode display screen 800(1) is illustrated. In this example, the testing mode display screen 800(1) includes an indication of a “move between sheets counter clockwise” action 802. Upon receiving key presses corresponding to a shortcut or hot key corresponding to the “move between sheets counter clockwise” action 802, the simulation of Microsoft Excel™ in the simulation portion 608(2) of the testing mode display screen 800 is updated to reflect the “move between sheets counter clockwise” action 802. Upon receiving key presses that do not correspond to a shortcut or hot key corresponding to the “move between sheets counter clockwise” action 802, the application gamification computing device 12 updates the testing mode display screen 800 to indicate that an incorrect shortcut or hot key has been entered.

The testing mode display screen 800(1) in this example further includes a timer 804 configured to increment until the key presses corresponding to the shortcut or hot key associated with the indicated action 802 are received. The timer 804 allows a user to visualize the time spent on particular tasks. In this example, a user can also initiate a “restart game” button 806 and a “main menu” button 808 using a keyboard in order to restart the game associated with the particular selected one of the subtopics 402 or navigate between display screens, respectively. Other types of selectable buttons and other features can also be provided on the learning mode display screen 800(1) in other examples.

Referring to FIG. 9, a screenshot of another exemplary testing mode display screen 800(2) is illustrated. In this example, the testing mode display screen 800(2) can be output following selection of a different one of the subtopics 402 than used to obtain the testing mode display screen 800(1) of FIG. 8. The exemplary testing mode display screen 800(2) in this example includes a question 900 regarding a formula illustrated in the simulation portion 608(3) of the testing mode display screen 800(2) as well as some optional answers 902 in order to test knowledge of formulas associated with the computer application. Other types of functions and formulas can also be tested in other ways in other examples.

Referring back to FIG. 2, in step 220, the application gamification computing device 12 receives key presses following output of the display screen with the indicated action in step 218. The key presses may or may not correspond with a shortcut or hot key associated with the action depending on whether the user utilized the correct shortcut or hot key to initiate the action.

Accordingly, in step 222, the application gamification computing device 12 determines whether the received key presses correspond with the shortcut or hot key associated with the action. If the application gamification computing device 45 determines that the received key presses do not correspond with the shortcut or hot key associated with the action, then the No branch is taken to step 224.

In step 224, the application gamification computing device 12 outputs an indication of the incorrect key presses on the display screen output in step 218. In this particular example, the application gamification computing device 12 can update the display screen to indicate that the key presses were incorrect with respect to the shortcut or hot key corresponding to the action without updating the simulation of the computer application in a simulated portion of the display screen. However, if the application gamification computing device 12 determines in step 222 that the received key presses do correspond with the shortcut or hot key associated with the action, then the Yes branch is taken to step 226.

In step 226, the application gamification computing device 12 updates the simulation of the computer application in the simulation portion of the display screen output in step 218 to reflect the action. Accordingly, a user of the application gamification computing device 12 can visualize the results of executing the actions, thereby facilitating more effective learning of shortcuts and hot keys that correspond with actions in the computer application.

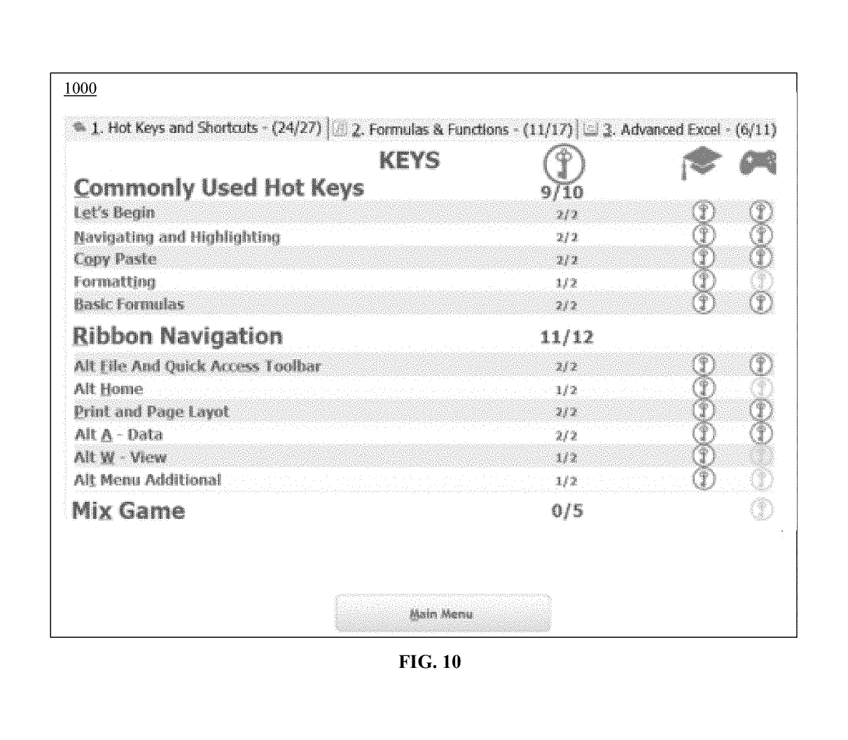

In step 228, the application gamification computing device 12 updates stored performance data for the user to indicate that a particular action, which is a portion of the actions associated with the subtopic selected in step 202, has been completed. Referring to FIG. 10, a screenshot of an exemplary performance display screen 1000 is illustrated. In one example, the performance display screen 1000 can be accessed from a main menu display screen or the topic display screen 300, for example. The performance display screen 1000 in this particular example illustrates whether the subtopics (e.g., subtopics 402) have been completed for two exemplary topics with respect to the learning and testing modes of interaction. In this example, completion is indicated by a key, such that obtaining a certain number of keys indicates completion of a topic for a computer application.

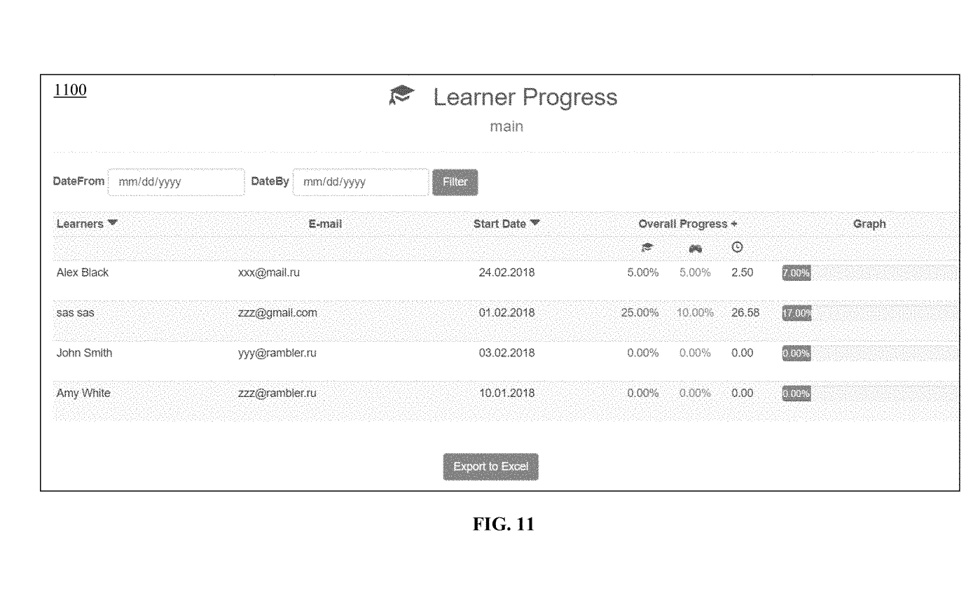

The performance data can also include information regarding time to complete certain games and/or comparison information or statistics for a plurality of employees associated with an organization or other users, and other types of performance data can also be used in other examples. Referring to FIG. 11, a screenshot of a main administrator performance display screen 1100 is illustrated. In this example, an administrator or other third party can determine the overall progress of particular employees or other users, for example, with respect to the multiple modes of operation. In other examples, an administrator can obtain visibility regarding the employee progress with respect to particular subtopics for each mode of operation. The progress can be indicated as complete or not complete, or as a percentage completion value, for example.

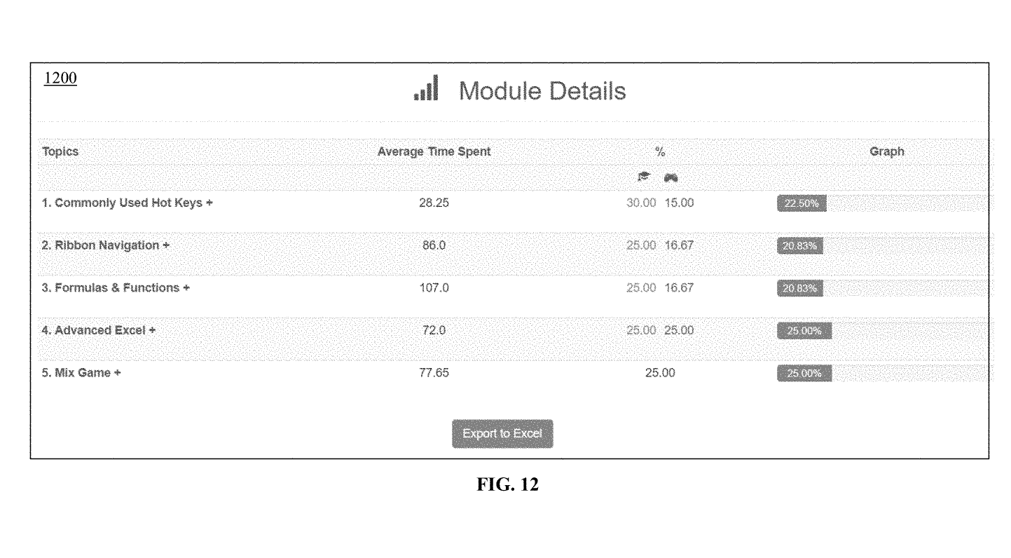

Referring to FIG. 12, a screenshot of a module detail administrator performance display screen 1200 is illustrated. In this example, an administrator or other third party can determine the performance of particular employees or other users, for example, with respect to the average time spent on particular sub topics for the different modes of operation. In other examples, an administrator can determine the average time spent for particular employees or other users for subtopics for each mode of operation. In yet other examples, other types of performance and/or progress data for users can also be generated and/or provided.

Also optionally, the performance data can be provided, such as via the communication network(s) 16, to a computing device associated with a third party provider of the gamification module 30. Providing the performance data to a third party can facilitate certification of completion of all of the topics and the entire associated training program, as well as publication (e.g., via a web page) of the users that have completed the training program, for example.

Referring back to FIG. 2, in step 230, the application gamification computing device 12 determines whether the subtopic selected in step 202 has been completed with respect to all of the associated actions. If the application gamification computing device 12 determines that the subtopic has not been completed, then the No branch is taken and the application gamification computing device 12 proceeds back to step 218 and outputs another display screen that includes an indication of another action associated with the subtopic selected in step 202 in order to proceed with the current game or testing session.

However, if the application gamification computing device 12 determines in step 230 that the subtopic has been completed, then the Yes branch is taken back to step 200 in this example and the main menu is provided (e.g., topic selection display screen is output), as described and illustrated in more detail earlier. In other examples, the application gamification computing device 12 can take other actions in response to determining whether the subtopic has been completed.

While an exemplary operation of the testing mode of the gamification module has been described and illustrated with reference to steps 218-230 as corresponding to a particular subtopic, in other examples, the testing mode can include a mixture of actions across various subtopics associated with different topics. In one example, a user can use the input device to select “mix game” in the topic display screen illustrated in FIG. 3 in order to access the mixed testing mode, which can be used to test shortcut or hot key efficiency and/or knowledge across different topics, optionally in a timed manner. Other modes of operation of the gamification module can also be utilized in other examples.

Accordingly, this technology advantageously facilitates relatively entertaining and effective teaching of efficient computer application utilization. In particular, with this technology, learning of shortcuts and hot keys is facilitated more effectively via gamification, resulting in more efficient utilization of computer applications by employees and other types of users. This technology requires computing devices and generates and outputs particular types of graphical user interfaces (GUIs) or display screens in order facilitate more effective learning of computer application utilization. The efficient utilization of computer applications results in improved productivity and utilization of organization resources, among other advantages.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating shortcut and hot key learning via computer application gamification, the method implemented by one or more application gamification computing devices and comprising:
outputting on a display device a display screen comprising a simulation of a computer application and an indication of an interaction with the computer application that can be initiated via a shortcut or hot key;
receiving one or more key presses corresponding to the shortcut or hot key and updating the simulation to reflect performance of the interaction within the computer application in response to the key presses;
updating a stored performance for a user to reflect completion of a portion of one of a plurality of subtopics, wherein each of the subtopics corresponds to a category of shortcut or hot key utilization associated with the computer application; and
outputting on the display device an indication of the stored performance in response to a received request, wherein the output indication of the stored performance comprises a completion status for each of the subtopics.

2. The method of claim 1, wherein the indication comprises the key presses corresponding to the shortcut or hot key when in a learning mode.

3. The method of claim 2, wherein the display screen further comprises a simulated keyboard and the method further comprises indicating with the simulated keyboard the key presses corresponding to the shortcut or hot key.

4. The method of claim 1, wherein the indication comprises an action corresponding to the shortcut or hot key, when in a testing mode, and the method further comprises:
receiving one or more other key presses different than the key presses corresponding to the shortcut or hot key; and
updating the display screen to indicate that the other key presses were incorrect with respect to the shortcut or hot key corresponding to the action, without updating the simulation.

5. The method of claim 4, further comprising outputting on the display screen a timer upon outputting the indication of the interaction that can be initiated via the shortcut or hot key, wherein the timer is configured to increment until the key presses corresponding to the shortcut or hot key are received.

6. The method of claim 1, further comprising facilitating navigation between the display screen and one or more other display screens, and interaction with the display screen and the other display screens, using only received inputs from a keyboard.

7. An application gamification computing device, comprising memory comprising programmed instructions stored thereon and one or more processors configured to execute the stored programmed instructions to:
output on a display device a display screen comprising a simulation of a computer application and an indication of an interaction with the computer application that can be initiated via a shortcut or hot key;
receive one or more key presses corresponding to the shortcut or hot key and update the simulation to reflect performance of the interaction within the computer application in response to the key presses;
update a stored performance for a user to reflect completion of a portion of one of a plurality of subtopics, wherein each of the subtopics corresponds to a category of shortcut or hot key utilization associated with the computer application; and
output on the display device an indication of the stored performance in response to a received request, wherein the output indication of the stored performance comprises a completion status for each of the subtopics.

8. The application gamification computing device of claim 7, wherein the indication comprises the key presses corresponding to the shortcut or hot key when in a learning mode.

9. The application gamification computing device of claim 8, wherein the display screen further comprises a simulated keyboard and the processors are further configured to execute the stored programmed instructions to indicate with the simulated keyboard the key presses corresponding to the shortcut or hot key.

10. The application gamification computing device of claim 7, wherein the indication comprises an action corresponding to the shortcut or hot key, when in a testing mode, and the processors are further configured to execute the stored programmed instructions to:
receive one or more other key presses different than the key presses corresponding to the shortcut or hot key; and
update the display screen to indicate that the other key presses were incorrect with respect to the shortcut or hot key corresponding to the action, without updating the simulation.

11. The application gamification computing device of claim 10, wherein the processors are further configured to execute the stored programmed instructions to output on the display screen a timer upon outputting the indication of the interaction that can be initiated via the shortcut or hot key, wherein the timer is configured to increment until the key presses corresponding to the shortcut or hot key are received.

12. The application gamification computing device of claim 7, wherein the processors are further configured to be capable of executing the stored programmed instructions to facilitate navigation between the display screen and one or more other display screens, and interaction with the display screen and the other display screens, using only received inputs from a keyboard.

13. A non-transitory machine readable medium having stored thereon instructions for facilitating shortcut and hot key learning via computer application gamification that, when executed by one or more processors, cause the processors to:
output on a display device a display screen comprising a simulation of a computer application and an indication of an interaction with the computer application that can be initiated via a shortcut or hot key;
receive one or more key presses corresponding to the shortcut or hot key and update the simulation to reflect performance of the interaction within the computer application in response to the key presses;
update a stored performance for a user to reflect completion of a portion of one of a plurality of subtopics, wherein each of the subtopics corresponds to a category of shortcut or hot key utilization associated with the computer application; and
output on the display device an indication of the stored performance in response to a received request, wherein the output indication of the stored performance comprises a completion status for each of the subtopics.

14. The non-transitory machine readable medium of claim 13, wherein the indication comprises the key presses corresponding to the shortcut or hot key when in a learning mode.

15. The non-transitory machine readable medium of claim 14, wherein the display screen further comprises a simulated keyboard and the instructions, when executed by the processors, further cause the processors to indicate with the simulated keyboard the key presses corresponding to the shortcut or hot key.

16. The non-transitory machine readable medium of claim 13, wherein the indication comprises an action corresponding to the shortcut or hot key, when in a testing mode, and the instructions, when executed by the processors, further cause the processors to:
receive one or more other key presses different than the key presses corresponding to the shortcut or hot key; and
update the display screen to indicate that the other key presses were incorrect with respect to the shortcut or hot key corresponding to the action, without updating the simulation.

17. The non-transitory machine readable medium of claim 16, wherein the instructions, when executed by the processors, further cause the processors to output on the display screen a timer upon outputting the indication of the interaction that can be initiated via the shortcut or hot key, wherein the timer is configured to increment until the key presses corresponding to the shortcut or hot key are received.

18. The non-transitory machine readable medium of claim 13, wherein the instructions, when executed by the processors, further cause the processors to facilitate navigation between the display screen and one or more other display screens, and interaction with the display screen and the other display screens, using only received inputs from a keyboard.
